(19) United States
(12) Patent Application Publication
(10) Pub. No.: US 2016/0146112 A1
(43) Pub. Date: May 26, 2016

(54) LIGHTWEIGHT GEAR ASSEMBLY FOR EPICYCLIC GEARBOX

(71) Applicant: GENERAL ELECTRIC COMPANY, Schenectady, NY (US)

(72) Inventors: Gert J. Van der Merwe, Cincinnati, OH (US); Donald Albert Bradley, Cincinnati, OH (US)

(21) Appl. No.: 14/900,643

(22) PCT Filed: Jun. 27, 2014
(86) PCT No.: PCT/US14/44579

§ 371 Date: Dec. 22, 2015

Related U.S. Application Data
(60) Provisional application No. 61/840,779, filed on Jun. 28, 2013.

(51) Int. Cl. F02C 7/36; F02K 3/06; F16H 57/08

(52) U.S. Cl. CPC F02C 7/36; F16H 57/08; F02K 3/06; F16H 2057/085; F05D 2260/40311

(57) ABSTRACT

An epicyclic gearbox comprises a gearbox housing including an inner cavity receiving an input shaft from a low pressure turbine and an output shaft connected to a fan. A sun gear is disposed within the housing and at least one planetary gear engages and orbits the sun gear. The at least one planetary gear is formed of a first material and an insert is disposed between a gear rim of the at least one planetary gear and a journal. The insert is formed of a second material distinct from the first material and of a weight which is lighter than the first material. The gearbox may include but is not limited to both star gearbox and planetary gearbox configurations.

### CROSS-REFERENCE TO RELATED APPLICATIONS

This application is a national stage application under 35 U.S.C. §371(c) of prior filed, co-pending PCT application serial number PCT/US2014/044579, filed on Jun. 27, 2014, which claims priority to U.S. Provisional Patent Application Ser. No. 61/840,779, titled “Lightweight Planet Design for Planet Gearbox” and having filing date Jun. 28, 2013, all of which is incorporated by reference herein.

### BACKGROUND

Present embodiments relate generally to planetary gearboxes. More specifically, but not by way of limitation, present embodiments relate to a lightweight planet configuration for use in planetary gearboxes in for example aircraft engines.

A typical gas turbine engine generally possesses a forward end and an aft end with its several core or propulsion components positioned axially there between. An air inlet or intake is located at a forward end of the engine. Moving toward the aft end, in order, the intake is followed by a compressor, a combustion chamber, and a turbine. It will be readily apparent to those skilled in the art that additional components may also be included in the engine, such as, for example, low-pressure and high-pressure compressors, and low-pressure and high-pressure turbines. This, however, is not an exhaustive list.

The compressor and turbine generally include rows of airfoils that are stacked axially in stages. Each stage includes a row of circumferentially spaced stator vanes and a row of rotor blades which rotate about a center shaft or axis of the turbine engine. The turbine engine may include a number of stages of static air foils, commonly referred to as vanes, interspaced in the engine axial direction between rotating air foils commonly referred to as blades. A multi-stage low pressure turbine follows the high pressure turbine.

An engine also typically has a first shaft axially disposed along a center longitudinal axis of the engine. The internal shaft extends between the high pressure turbine and the high pressure air compressor, such that the turbine provides a rotational input to the air compressor to drive the compressor blades. The first and second rotor disks are joined to the compressor by a corresponding rotor shaft for powering the compressor during operation. A second shaft joins the low pressure turbine and the low pressure compressor. The second shaft may also drive turbo fan for powering an aircraft in flight. This may be direct or indirect, for example through a gearbox.

In operation, air is pressurized in a compressor and mixed with fuel in a combustor for generating hot combustion gases which flow downstream through turbine stages. The turbine stages extract energy from the combustion gases. A high pressure turbine first receives the hot combustion gases from the combustor and includes a stator nozzle assembly directing the combustion gases downstream through a row of high pressure turbine rotor blades extending radially outwardly from a supporting rotor disk. The stator nozzles turn the hot combustion gas in a manner to maximize extraction at the adjacent downstream turbine blades. In a two stage turbine, a second stage stator nozzle assembly is positioned downstream of the first stage blades followed in turn by a row of second stage rotor blades extending radially outwardly from a second supporting rotor disk. The turbine converts the combustion gas energy to mechanical energy.

Due to extreme temperatures of the combustion gas flow path and operating parameters, the stator vanes and rotating blades in both the turbine and compressor may become highly stressed with extreme mechanical and thermal loading. Additionally, gas turbine engines often comprise turbofans which provide thrust. These turbofans also utilize airfoils to cause air movement from the forward toward the aft end of the engine and due to operating temperatures may be formed of lightweight composites.

A desirable characteristic or goal of gas turbine engines is to improve performance of airfoil structures. One known means for increasing performance of a turbine engine is through weight reduction of components in the engine. One means of reducing weight of engine components is to use lighter weight materials. With regard to the fan for example, the fan may be driven by the low pressure turbine shaft. The driving occurs through a transmission gearbox according to some engine designs. These transmissions may involve various gear systems such as epicyclic star and planetary gear systems.

Gears are required to transmit large forces and torque loads and therefore are often formed of steel material. In epicyclic gear systems, there are a number of gears which are called planetary gears. These planetary gears rotate about a central axis and may orbit about a sun gear during such rotation. In a planetary arrangement the planetary gears may be connected to a carrier which rotates relative to a fixed ring gear surrounding the planets. Alternatively, in a star arrangement the planets may be non-orbiting by connection to a fixed carrier so that the ring gear turns. In these embodiments, where steel gears are utilized, it is desirable to reduce the amount of steel utilized to reduce weight and increase engine performance. In a planetary arrangement reducing the weight of the planetary gears also serves to improve planet bearing loading through reduction of centrifugal load of orbiting planetary gears.

As may be seen by the foregoing, it would be desirable to overcome these and other deficiencies with gas turbine engine components. More specifically, it would be desirable to reduce weight of the gearbox components without adversely affecting operation, strength or fatigue strength of the structure.

The information included in this Background section of the specification, including any references cited herein and any description or discussion thereof, is included for technical reference purposes only and is not to be regarded subject matter by which the scope of the invention is to be bound.

### BRIEF DESCRIPTION OF THE INVENTION

According to aspects of the present embodiments, a lightweight gear assembly for an epicyclic gearbox is provided. The gear assembly, for example a planetary gear assembly, comprises a relatively heavier gear rim of a first material having expanded diameter and an insert formed of a relatively second lighter-weight material in order to reduce the amount of relatively heavier first material. The lighter weight second material is provided by having a reduced density relative to the first material. This reduces the overall weight of the planetary gear assembly while maintaining the load carrying capabilities of the planetary gears and bearings.

According to some embodiments, an epicyclic gearbox includes a gearbox housing including an inner cavity receiving an input shaft from a low pressure turbine and an output shaft to a fan, a sun gear a disposed is within the housing, and at least one planetary gear which engages and orbits the sun gear. The at least one planetary gear may be formed of a first material. An insert is disposed between a gear rim of the at least one planetary gear and a journal bearing. The insert may be formed of a second material distinct from the first material having a density which is less than the first material.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the lightweight planetary design may be gleaned from the disclosure herein. Therefore, no limiting interpretation of this summary is to be understood without further reading of the entire specification, claims, and drawings included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

The above-mentioned and other features and advantages of these exemplary embodiments, and the manner of attaining them, will become more apparent and the lightweight gear assembly for epicyclic gearbox will be better understood by reference to the following description of embodiments taken in conjunction with the accompanying drawings, wherein:

FIG. 1 is a cross-sectional view of a gas turbine engine including a planetary gearbox disposed between a low pressure turbine shaft and a fan;

FIG. 2 is a forward looking aft view of a planetary gearbox;

FIG. 3 is an isometric view of a portion of a planetary gearbox with the carrier removed for clarity;

FIG. 4 is a section view of the planetary gearbox and,

FIG. 5 is a cross-sectional view of a second gas turbine engine including a star gearbox configuration disposed between a low pressure turbine shaft and fan.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present disclosure covers such modifications and variations as come within the scope of the appended claims and their equivalents.

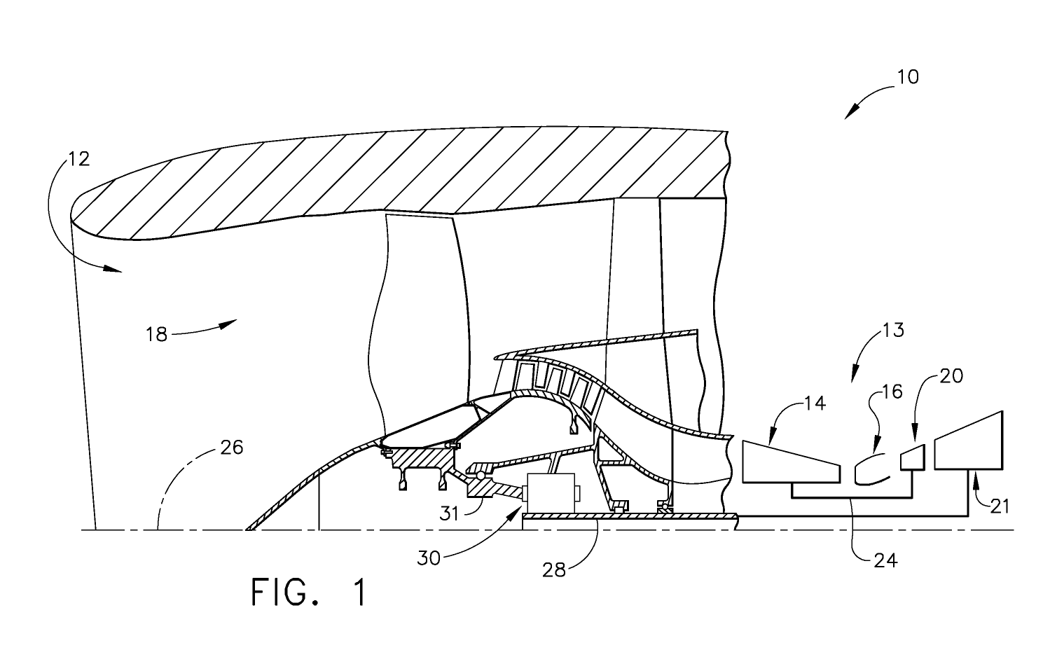

Referring to FIGS. 1-5 various embodiments of a lightweight gear assembly for an epicyclic gearbox are depicted. The planetary gears are bored or formed having larger than normal axial bearing apertures. The larger aperture reduces weight of the relatively heavy metal, for example steel, utilized to form the gear. An insert formed of a second distinct material is positioned within the bore and between the gear and the bearing. The second material may include, but is not limited to, aluminum, composites, titanium, magnesium, alloys thereof or variations or combinations. The insert of the second material has a lesser density than the first material and therefore may be lighter than the first material.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine nozzle, or a component being relatively closer to the engine nozzle as compared to another component.

As used herein, the terms “radial” or “radially” refer to a dimension extending between a center longitudinal axis of the engine and an outer engine circumference. The use of the terms “distal” or “distally,” either by themselves or in conjunction with the terms “radial” or “radially,” refers to moving in a direction toward the outer engine circumference, or a component being relatively closer to the outer engine circumference as compared to another component.

Referring initially to FIG. 1, a schematic side section view of a gas turbine engine 10 is shown. The function of the turbine is to extract energy from high pressure and temperature combustion gases and convert the energy into mechanical energy for work. The gas turbine engine 10 has an engine inlet end 12 wherein air enters the core or propulsor 13 which is defined generally by a compressor 14, a combustor 16 and a multi-stage high pressure turbine 20. Collectively, the propulsor 13 provides power during operation. The gas turbine engine 10 may be used for aviation, power generation, industrial, marine or the like.

In operation air enters through the engine inlet end 12 of the gas turbine engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn causes rotation of the shaft 24 about engine axis 26. The shaft 24 may be a high pressure shaft for example. The shaft 24 passes toward the front of the engine to continue rotation of the one or more stages of the compressor 14, a fan 18 or inlet fan blades, depending on the turbine engine design. A low pressure turbine 21 may also be utilized to extract further energy and power additional compressor stages.

Referring still to FIG. 1, the engine inlet 12 includes a fan 18 having a plurality of blades. The fan 18 is connected by shaft 28 to the low pressure turbine 21 and creates thrust for the turbine engine 10. Although discussed with respect to the various blades of the fan 18, the multi-material airfoil may be utilized with various airfoils within the gas turbine engine 10. Additionally, the multi-material blade may be utilized with various airfoils associated with structures other than the turbine engine as well.

FIG. 1 additionally depicts an epicyclic gearbox 30, for example a planetary gearbox. The epicyclic gearbox 30 of the embodiment is a planetary gearbox, however other types of gearboxes may be utilized with the embodiments described herein, for example wherein embodiments may be utilized with star gear configuration. The instant epicyclic gearbox 30 receives input from a low pressure turbine shaft 28. On the output side, the epicyclic gearbox 30 is connected via a shaft 31, for example an output shaft, to fan 18. During engine operation, the low pressure turbine shaft 28 rotates, and turns the gear train on the inside of the epicyclic gearbox 30 to provide an output which rotates the fan 18.

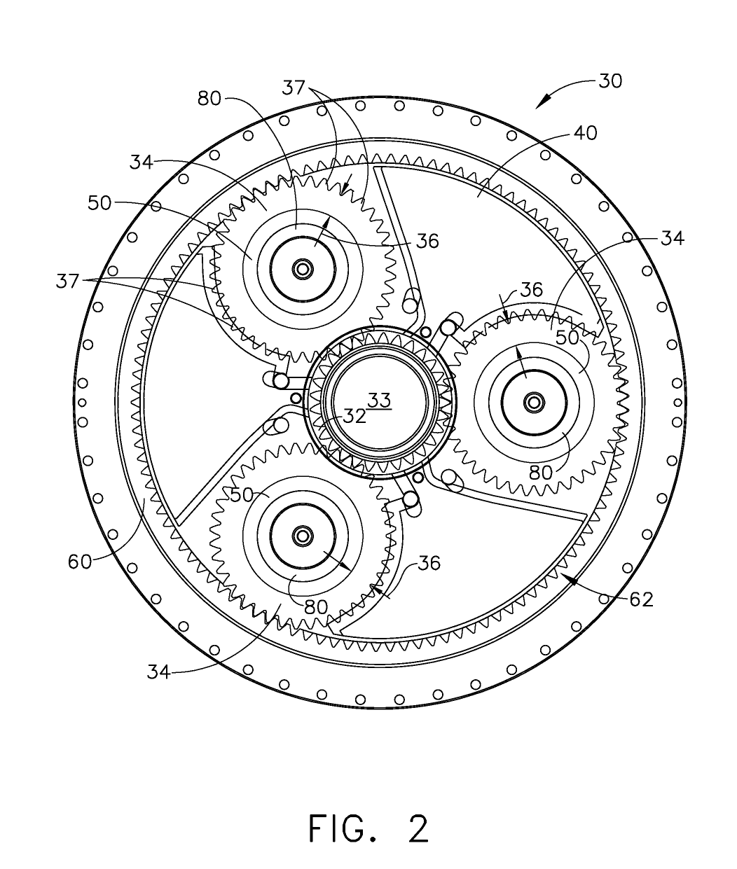

Referring now to FIGS. 1 and 2, the epicyclical gearbox 30 is described in combination with the section and forward looking aft views. The epicyclic gearbox 30 includes a sun gear 32, a plurality of planetary gears 34, a ring gear 60 and a carrier 40. In this embodiment, the ring gear 60 surrounding planetary gears 34 is fixed and this arrangement is therefore referred to as a planetary gearbox configuration.

The epicyclic gearbox 30 includes a sun gear 32 which is centrally disposed within the geartrain and about which a plurality of planetary gears 34 are disposed. The sun gear 32 receives an input driving torque from the shaft 28 (FIG. 1), for example the low pressure turbine shaft. The sun gear 32 has a central aperture 33 for input torque from the drive shaft and a plurality of teeth 37 disposed about the sun gear 32. The teeth 37 engage the plurality of planetary gears 34 disposed about the sun gear 32. When the sun gear 32 rotates with the input shaft, for example shaft 28, the planetary gears 34 also rotate.

Additionally, the planetary gears 34 orbit the sun gear 32. In the embodiments, the planetary gears 34 retained in a carrier 40 which allows orbiting of the sun gear 32 with the rotation of the planetary gear 34. An insert 50 may be positioned between the gear rim 36 of planetary gear 34 and the journal 80. The insert 50 is formed of a second material which is distinct from the first steel material forming the gear rim 36. Also, the second material defining the insert 50 is formed of a material which is lighter weight than the first material, steel, such as aluminum, a composite material including but not limited to composite metal matrix, or any other material suitable to withstand the temperature and strength requirements of the operating environment. Additionally, titanium or titanium alloys may be utilized. These materials may all have characteristics wherein the materials or combinations have low density being less than steel or less than about 0.2 pounds per cubic inch. By providing a lower density second material, the weight of the second material is decreased as compared to the weight of the gear rim 36 first material. The average load on the journal bearing is about 1000 to about 1500 pounds per square inch (psi) and the second material should be able to support such but need not have the strength of the first material defining the gear rim 36.

Disposed radially outwardly of the planetary gears 34 is a ring gear 60. The ring gear 60 may be fixed or may rotate due to rotation of the planetary gears 34. The ring gear 60 includes a plurality of gear teeth 62 which circumscribe and engage planetary gears 34 and the carrier 40. The ring gear 60 may be formed of one part or multiple parts which are assembled in a variety of manners. According to the instant embodiment, the ring gear 60 is fixed so that the carrier 40 and planetary gears 34 orbit the sun gear 32 during operation. According to alternatives, the planetary gears 34 may be fixed with regard to orbiting motion about the sun gear 32 wherein the ring gear 60 may be free to rotate about the planetary gears 34 and the sun gear 32. In the existing embodiment, the carrier 40 is connected to the fan 18 to cause rotation of the fan 18 when torque is input to the sun gear 32.

Each of the planetary gears 34 includes a plurality of teeth 37 disposed about a gear rim 36. The gear rim 36 extends between the gears and the central opening of the planetary gear 34. As previously mentioned, the planetary gears 34 are made of steel which is relatively heavy and provides an opportunity for weight reduction to improve engine performance. Various types of steels or steel alloys may be utilized and the description therefore is not limited to a single steel type. Present embodiments decrease the dimension of the gear rim 36 depicted so that the central aperture of each planetary gear 34 is larger than existing art structures. With the decrease of the gear rim 36 dimension in the radial dimension, the amount of steel in the planetary gear 34 is reduced. This reduces weight in the part. In order to properly size the part to fit on the journal 80 for rotation, an insert 50 is positioned within the gear rim 36.

In operation, the epicyclic gearbox 30 provides a speed reducing function. The low pressure shaft rotates at a speed which is too great for operation of the fan 18. The epicyclic gearbox 30 reduces input speed to the fan 18 so that the speed is in an appropriate range for operation. More specifically, the torque input to the sun gear 32 from the low pressure turbine shaft 28, is of a higher speed than is output to the fan 18 by way of speed reduction through the epicyclic gearbox 30.

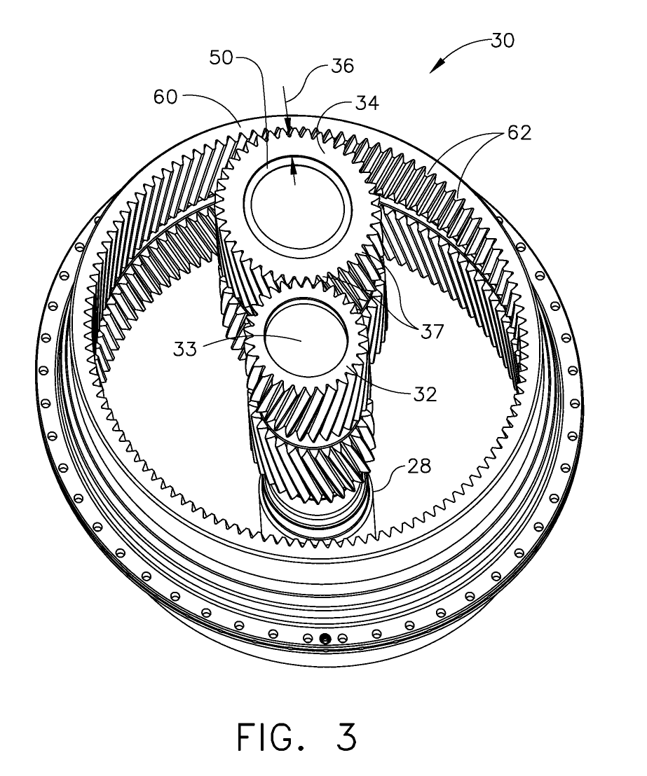

Referring now to FIG. 3, an isometric view of the epicyclic gearbox 30 is depicted with the carrier 40 (FIG. 2) removed. The sun gear 32 is disposed centrally within the ring gear 60 and a planetary gear 34 located radially outward of the sun gear 32 and is in gear tooth engagement with both the sun gear 32 and the ring gear 60. As described earlier, the planetary gear 34 orbits the sun gear 32 during rotation and the ring gear 60 is fixed to provide for the orbiting movement of the planetary gear 34.

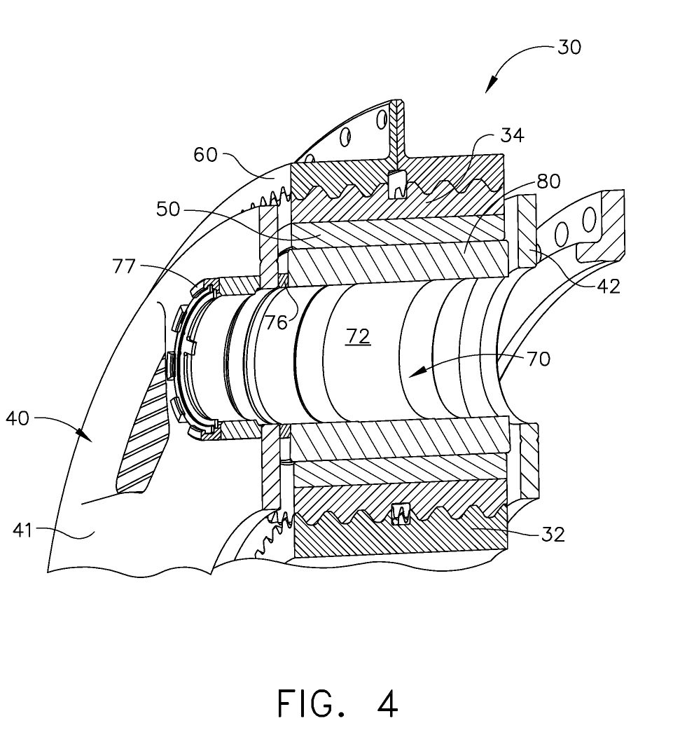

During operation of the gear assembly, the gear reaction loads can cause the circle shape of the gear to deflect which may inhibit proper functioning of the planet fluid-film journal 80 (FIG. 2). This deflection is limited or inhibited by increasing the size of the gear rim 36. This can be accomplished even while substituting a lighter weight material such as aluminum for a portion of the steel making of the planetary gear 34 due to the second moment of inertia. A small increase in the diameter of the planetary gear produces a large increase in the cross-sectional stiffness. According to instant embodiments, the size of the gear rim 36 is decreased in order to reduce weight. However, an insert 50 is utilized to provide the rigidity needed to limit gear reaction load deflection. The insert 50 is disposed within the bearing bore of the planetary gear 34 between the gear rim 36 and the journal 80 (FIG. 4). Additionally, the bearing size can be reduced to the use of lower weight planetary gears within the system.

Referring now to FIG. 4, a partial cross-sectional view of an epicyclic gearbox 30 is depicted. Specifically, the epicyclic gearbox 30 includes a central journal structure 70 including a support pin 72 about which the planetary gear 34 rotates. The support pin 72 may include an inlet for oil to enter the cylindrical body for dispersion into the planetary gear 34 journal 80 for purpose of lubrication.

The journal 80 is located on the outer surface of the support pin 72. The journal 80 is fixed to the support pin 72 and the planetary gear 34 and an insert 50 rotate about the journal support pin 72. A spacer 76 is disposed on the circumferential surface of the support pin 72. The spacer 76 is provided to inhibit movement of the support pin 72 and journal 80 in the axial direction between walls of the carrier 40. The support pin 72 may be threaded at an end near the spacer 76 so that a spanner nut 77 may be applied to lock the support pin axially in one direction, and the spacer 76 may inhibit axial movement in the opposite axial direction.

Disposed radially outward of the journal 80, between the journal 80 and the planetary gear 34 is the insert 50. The insert 50 is formed of a second lightweight material distinct from the first steel material of the planetary gear 34. The second material is distinct or different from the first material and therefore has different weight and strength characteristics which must be commensurate with use within the high temperature and pressure operating conditions of the gas turbine engine 10. The insert 50 is positioned in the area of the gear rim which is removed to reduce weight. With a portion of the steel gear 34 removed, the insert 50 is placed in this area of the gear to compensate for the removed material at a lesser weight than that of the gear. The decreased weight is provided by use of the second material which has a lower density than the first material.

The insert 50 may be positioned within the gear rim 36 in a variety of ways. Non-limiting examples include the use of adhesive, welding, or press-fit of the insert 50 into the gear rim 36 or onto the journal 80. Further, mechanical connection may be utilized between the insert 50 and the gear rim 36. For example, a spline-fitting or other mechanical interface may be utilized to connect the parts and transmit torque while also transferring load to the journal 80.

The carrier 40 may be a one piece or multi-piece construction which provides structural rigidity. The carrier 40 includes spaced apart walls 41, 42 which are spaced in the axial direction. The support pin 72 extends in the axial direction between the walls 41, 42. The planetary gear 34 and the insert 50 are disposed between the walls so that these structures are retained therein.

In the instant embodiment, the shaft 28 (FIG. 1) is shown extending to the epicyclic gearbox 30. The shaft extends to the sun gear 32 causing rotation thereof. The sun gear causes rotation and orbital movement of the planetary gears 34 and the carrier 40. The ring gear 60 is fixed in the illustrated embodiment causes the planetary gears 34 and carrier 40 to orbit the sun gear 32. Since the carrier 40 rotates during operation, the fan 18 may be connected by shaft to the carrier 40 for operation. In alternate embodiments, the carrier 40 may be fixed and the fan shaft may be connected to the ring gear 60 for rotation. This is generally referred to as a star gear configuration.

According to the instant embodiments, the diameter and thickness of the insert 50 may vary depending on loads that the planetary gear 34 and journal 80 will see during operation. In gear systems, various loads are designed into the gear and bearing structure. For example, the epicyclic gearbox 30 journal 80 see torque loads and centrifugal loads of the planetary gear 34 mass orbiting in the carrier 40. According to some embodiments, the insert 50 may be formed of aluminum or other materials previously described in this disclosure including, but not limited to, other lightweight materials such as titanium, magnesium or alloys thereof may be utilized. The planetary gear 34 mass may be reduced by about more than 30%, and more specifically about 30% to about 60% and in at least one embodiment about 41%. Further, the total gearbox 30 mass may be reduced between about 8% and about 25%, and according to one embodiment, by about 13%. Further, the load of the planet bearing may be reduced between about 15% and about 50% by about 29%. Various materials utilized are capable to suitably handle average pressure load on the journal 80 and temperatures of up to about 400 degrees Fahrenheit.

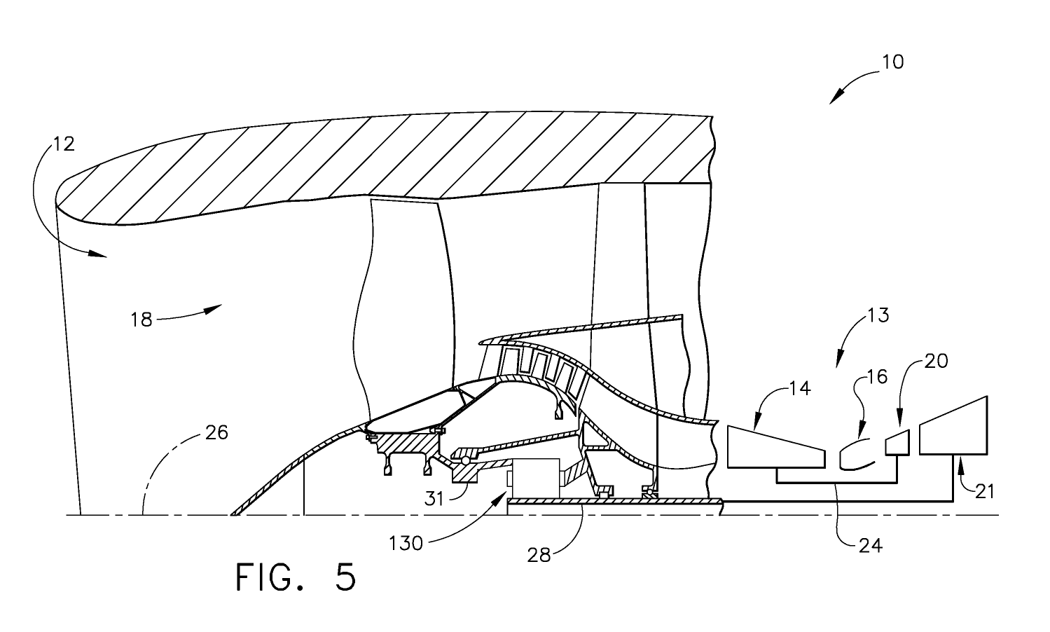

While certain embodiments are described and depicted, it should be understood from the instant disclosure that the lightweight gear assembly may be utilized with star gearbox configurations, planetary gearbox configurations, epicyclic differential, or compound, multi-stage configurations for speed reducing or increasing gearboxes with gas turbine engines. For example, as shown in FIG. 5, the schematic gearbox 130 is shown. This embodiment differs in that shaft 31 which drives fan 18 is connected to the ring gear or an intermediate part, such as a frame member, so that the fan 18 is driven by the rotating ring gear or intermediate part connected to the rotating ring gear. The connection between the gearboxes 30, 130 and the fan 18 may be direct or indirect, such as by the shaft 31 depicted.

Further, while multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

What is claimed is:

1. An epicyclic gearbox, comprising:
a gearbox housing including an inner cavity receiving an input shaft from a low pressure turbine and an output shaft to a fan;
a sun gear disposed within said housing;
at least one planetary gear which engages and orbits said sun gear;
said at least one planetary gear being formed of a first material;
an insert disposed between a gear rim of said at least one planetary gear and a journal;
said insert being formed of a second material distinct from said first material and of a density which is less than said first material.

2. The epicyclic gearbox of claim 1, wherein said insert is generally cylindrical.

3. The epicyclic gearbox of claim 1 wherein said epicyclic gearbox is a star gear configuration.

4. The epicyclic gearbox of claim 3 further comprising a carrier which is fixed and a ring gear which rotates.

5. The epicyclic gearbox of claim 4, wherein rotation of said ring gear drives said fan.

6. The epicyclic gearbox of claim 1 wherein said gearbox is a planetary gearbox configuration.

7. The epicyclic gearbox of claim 6 further comprising a carrier, said carrier establishing orbiting of said at least one planetary gear about said sun gear.

8. The epicyclic gearbox of claim 7, wherein said carrier drives rotation of said fan.

9. The epicyclic gearbox of claim 6, further comprising a ring gear-64 disposed outwardly of said at least one planetary gear.

10. The epicyclic gearbox of claim 9, wherein said ring gear is fixed and causes orbiting of said at least one planetary gear.

11. The epicyclic gearbox of claim 10 further comprising a carrier wherein said at least one planetary gear is located.

12. The epicyclic gearbox of claim 11, wherein said carrier rotates and is drivably connected to said fan to cause rotation of said fan.

13. The epicyclic gearbox of claim 1, wherein the second material is of a lighter weight than the first material.

14. The epicyclic gearbox of claim 13, said insert being formed of one of aluminum, a composite material, composite metal matrix, titanium, titanium alloys, magnesium or magnesium alloys.

15. The epicyclic gearbox of claim 1, wherein said insert is connected to said gear rim by one of an adhesive, a weld, a press-fit or a mechanical interface.
